(19) United States
(12) Patent Application Publication
(10) Pub. No.: US 2011/0122440 A1
(43) Pub. Date: May 26, 2011

(54) OPERATION APPARATUS, CONTROLLING METHOD AND STORAGE MEDIUM THEREFOR

(75) Inventor: Minoru Akazawa, Kawasaki-shi (JP)

(73) Assignee: CANON KABUSHIKI KAISHA, Tokyo (JP)

(21) Appl. No.: 12/950,768

(22) Filed: Nov. 19, 2010

(30) Foreign Application Priority Data
Nov. 25, 2009 (JP) 2009-267613

(51) Int. Cl. H04N 1/00

(52) U.S. Cl. 358/1.15

(57) ABSTRACT

An operation apparatus is detachable with respect to a plurality of image processing apparatuses and includes a display unit which can display a selection screen for selecting an image processing apparatus as an operation target from among the plurality of image processing apparatuses The operation apparatus includes a control unit configured to display the selection screen on the display unit if the operation apparatus is started up when the operation apparatus is not mounted on any of the plurality of image forming apparatuses, and establish communication with an image processing apparatus selected via the selection screen. The control unit does not display the selection screen on the display unit if the operation apparatus is started up when the operation apparatus is mounted on any of the plurality of image forming apparatuses, and establishes communication with the image processing apparatus on which the operation apparatus is mounted.

### BACKGROUND OF THE INVENTION

1. Field of the Invention

The present invention relates to an operation apparatus, and a controlling method and storage medium therefor.

2. Description of the Related Art

In recent years, the multifunction peripheral market has been characterized by the appearance of products responding to the demand for multicolor printing and bookbinding using a combination of various options, for example, enabling saddle stitch binding, cutting, folding processing, and the like. In particular, the printing and publishing industries have been greatly affected by high-speed multifunction peripherals that enable high-speed multicolor printing and bookbinding.

There are various types of options that can be combined with such high-speed multifunction peripheral and each of these options are relatively large, so that they require large installation spaces. For example, this type of apparatus in total may require a distance of more than 10 meters from an operation panel for enabling operations to a finishing unit that executes print output.

The operation of this type of high-speed multifunction peripheral may be extremely labor intensive as a result of operation while referring to the operation panel for information related to paper jams, exchanging consumable items, or the like. When it is assumed that a paper jam has occurred in the finishing unit, an operator needs to perform operations, such as checking the operation panel, moving more than 10 meters to the finishing unit to clear the jam, returning to the operation panel to check, and so on. Consequently, a detachable operation panel would be very useful in such an operational environment. If the operation panel could be removed, the operator can bring the operation panel to the operation site and clear paper jams or exchange of consumable items while confirming the display thereon.

A wireless communication configuration for operations will be required if a detachable operation panel is used in conjunction with a high-speed multifunction peripheral. In addition, it is useful if the operation panel can operate a plurality apparatuses.

Japanese Patent Application Laid-Open No. 9-146731 discusses a technique of selecting an apparatus for print output from a plurality of print apparatuses to thereby execute printing command operations. According to this conventional technique, a print apparatus can be selected every time printing is executed, so that printing that conforms with current operating conditions can be executed.

If a detachable operation panel is used in the context of a high-speed multifunction peripheral, there would be situations in which there is no need for a user to select an apparatus to perform operations. For example, the case where a power source could be switched ON with the operation panel remaining attached to the multifunction peripheral can be considered. When setting the power source to ON via the operation panel by standing in front of a main unit of this type huge multifunction peripheral, most users of multifunction peripherals may bring a document for use in the multifunction peripheral main unit.

However in the conventional technique, even when it is almost completely certain that the apparatus main unit will be used in this manner, when switching the power source of the operational panel to the ON position, the user must use the operation panel to select the apparatus main unit to perform operations. This type of superfluous operation is extremely cumbersome for a user.

### SUMMARY OF THE INVENTION

The present invention is directed to an arrangement increasing convenience by omitting superfluous operations including selection by a user of an apparatus main unit of an operation target if the operation target to be operated by an operation panel is clear at startup of the operation panel.

According to an aspect of the present invention, an operation apparatus detachable with respect to a plurality of image processing apparatuses and including a display unit which can display a selection screen for selecting an image processing apparatus as an operation target from among the plurality of image processing apparatuses includes a control unit configured to display the selection screen on the display unit if the operation apparatus is started up when the operation apparatus is not mounted on any of the plurality of image forming apparatuses, and establish communication with an image processing apparatus selected via the selection screen, wherein the control unit does not display the selection screen on the display unit if the operation apparatus is started up when the operation apparatus is mounted on any of the plurality of image forming apparatuses, and establishes communication with the image processing apparatus on which the operation apparatus is mounted.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic figure illustrating an operating environment of an image forming apparatus according to a first exemplary embodiment of the present invention.

FIG. 2 is a block diagram illustrating a control configuration of an operation panel, a home position, and a main unit.

FIG. 3 illustrates use of a detachable operation panel that characterizes the present invention is detached from the home position on the main unit.

FIG. 4 illustrates transition of a display screen on a liquid crystal display (LCD) when a power source is turned ON and the detachable operation panel that characterizes the present invention is detached from the home position on the main unit.

FIG. 5 illustrates use of the detachable operation panel that characterizes the present invention is positioned at the home position on the main unit.

FIG. 6 illustrates the transition a display screen on the LCD when the power source is turned ON and the detachable operation panel that characterizes the present invention is positioned at the home position on the main unit.

FIG. 7 is a flowchart illustrating processing executed when the power source of the detachable operation panel that characterizes the present invention is turned ON.

### DESCRIPTION OF THE EMBODIMENTS

Various exemplary embodiments, features, and aspects of the invention will be described in detail below with reference to the drawings.

The exemplary embodiment will be described using an example of an image forming apparatus (image processing apparatus). However, no limitation on the present invention is not limited to the below described exemplary embodiment.

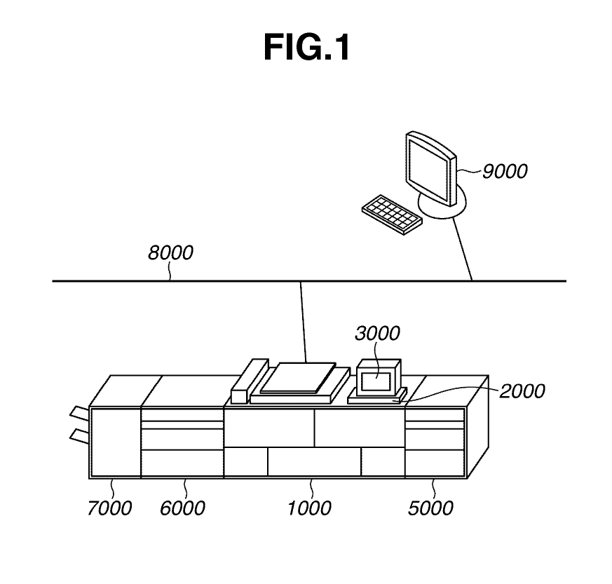

FIG. 1 is a schematic figure illustrating an operating environment of an image forming apparatus according to a first exemplary embodiment of the present invention. The image forming apparatus (image processing apparatus) according to the present exemplary embodiment can respond to a demand for multicolor printing and booking binding by combination of various options enabling saddle stitch binding, cutting, folding processing and the like in a print on demand (POD) apparatus.

The image forming apparatus (image processing apparatus) illustrated in FIG. 1 combines a paper deck 5000, a binder 6000, and a finisher 7000 with a main unit 1000 of the image forming apparatus (hereafter referred to as “main unit”) .

The main unit 1000 is connected to a personal computer 9000 via a local area network (LAN) 8000. In the personal computer 9000, a print job is produced which includes settings such as preparation and editing of individual pages, bookbinding, cutting and folding. The resulting print job is transmitted to the main unit 1000 via the LAN 8000.

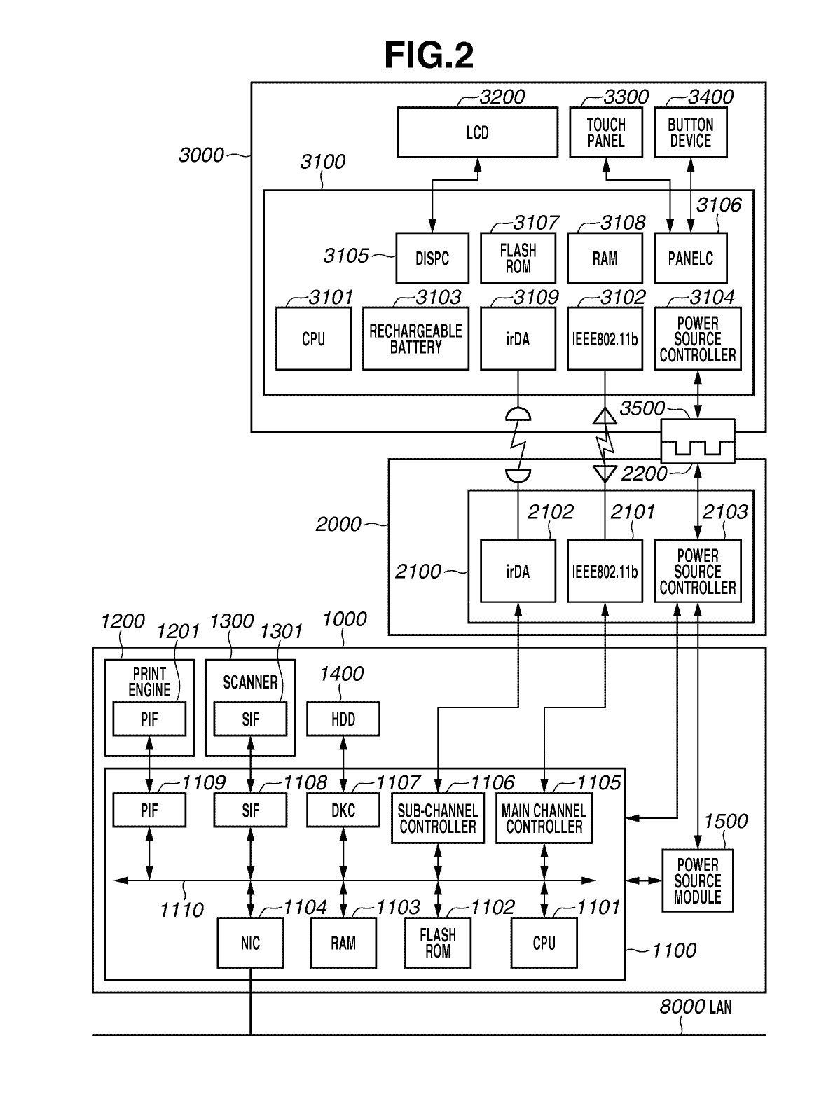

In FIG. 1, a detachable operation panel 3000 that characterizes the present invention is illustrated as mounted on a home position 2000 provided on the main unit 1000. When the detachable operation panel 3000 is mounted on the home position 2000, the detachable operation panel 3000 can be charged with power supplied from the home position 2000. Options including the paper deck 5000, the binder 6000, the finisher 7000, and the like have no direct relationship with the present invention and therefore detailed description thereof is omitted. FIG. 2 is a block diagram illustrating a control configuration of the operation panel 3000, the home position 2000, and the main unit 1000. A module respectively configuring the operation panel 3000, the home position 2000, and the main unit 1000 will be described below.

Firstly the main unit 1000 will be described. As illustrated in FIG. 2, the main unit 1000 is mainly configured by a controller board 1100, a print engine 1200, a scanner 1300, a hard disk drive (HDD) 1400, and a power source module 1500. The respective devices are operated by power supplied from the power source module 1500.

The controller board 1100 includes a central processing unit (CPU) 1101, a flash read only memory (FLASH ROM) 1102, a random access memory (RAM) 1103, a network interface card (NIC) 1104, a main channel controller 1105, a sub-channel controller 1106, a disk controller (DKC) 1107, a scanner interface (SIF) 1108, and a printer interface (PIF) 1109. The devices 1101 to 1109 are connected with each other via a bus 1110.

The CPU 1101 is a processor that executes overall control of each device connected to the bus 1110 and that acts as a firmware module for control programs stored in the FLASH ROM 1102 and the HDD 1400. The RAM 1103 functions as a work area and a main memory for the CPU 1101.

The NIC 1104 performs bidirectional exchange of data with the personal computer 9000 and another image forming apparatus via the LAN 8000. The HDD 1400 is accessed via the DKC 1107 and is used not only for storage of firmware modules but also as a temporary storage area for images.

The scanner 1300 mounted on the main unit 1000 includes a reading sensor, a document conveyance mechanism, or the like (not illustrated). The reading sensor and the document conveyance mechanism are controlled based on the firmware module executed by the CPU 1101 via the SIF 1108 that is mounted on the controller board 1100 or an SIF 1301 that is mounted in the scanner 1300. As a result, a document is read by the reading sensor and read data is transmitted to the controller board 1100 via the SIF 1301 and the SIF 1108.

The print engine 1200 built into the main unit 1000 includes an electrophotographic recording unit, a recording paper cassette, a paper conveyance unit, and the like (all not illustrated). A print request based on a print job is transmitted from the controller board 1100 via the PIF 1109 and a PIF 1201 mounted on the print engine 1200. The recording unit and the paper conveyance unit are controlled based on the firmware module executed by the CPU 1101 via the PIF 1109 and the PIF 1201 in the similar manner. Consequently, an image is formed on a sheet according to the print request.

The main channel controller 1105 and the sub-channel controller 1106 are used when the main unit 1000 exchanges data with the detachable operation panel 3000 which characterizes the present invention. This operation will be described in detail below.

Next, the home position 2000 will be described. As illustrated in FIG. 2, the home position 2000 is configured mainly from a main board 2100 and a connector 2200. The main board 2100 configuring the home position 2000 is configured from an Institute of Electrical and Electronic Engineers (IEEE) 802.11b module 2101, an Infrared Data Association (irDA) module 2102, and a power source controller 2103.

The IEEE802.11b module 2101 is connected to the main channel controller 1105 of the controller board 1100 and mediates wireless communication with the operation panel 3000 based on a request from the controller board 1100.

The irDA module 2102 is connected with the sub-channel controller 1106 of the controller board 1100 and mediates infrared communication with the operation panel 3000 based on a request from the controller board 1100.

The power source controller 2103 is connected with the power source module 1500. The IEEE802.11b module 2101 and the irDA module 2102 are supplied with power via the power source controller 2103. The power source controller 2103 is connected with the connector 2200, and when a connector 3500 of the operation panel 3000 is in a contact state, power is also supplied to the operation panel. In addition, the power source controller 2103 monitors a power supply state, detects whether there is a connection state (mounting state) between the home position 2000 and the operation panel 3000, and transmits the detection result to the controller board 1100.

Next, the operation panel 3000 will be described. As illustrated in FIG. 2, the detachable operation panel 3000 mainly includes a main board 3100, an LCD 3200, a touch panel 3300, a button device 3400, and a connector 3500.

The main board 3100 mainly includes a CPU 3100, an IEEE802.11b module 3101, a rechargeable battery 3103, an irDA module 3109, a power source controller 3104, a display controller (DISPC) 3105, a panel controller (PANELC) 3106, a FLASH ROM 3107, and a RAM 3108. These respective modules 3101 to 3108 are connected with each other via a bus (not illustrated) in the similar manner to the controller board 1100.

The CPU 3101 is a processor that executes overall control of each device connected via the bus and that acts as a firmware module for control programs stored in the FLASH ROM 3107. The RAM 3108 functions as a work area and a main memory for the CPU 1101, and as a video image area displayed in the LCD 3200.

The display controller (DISPC) 3105 transmits a video image developed in the RAM 3108 to the LCD 3200 in response to a request from the CPU 3101, and controls the LCD 3200. As a result, an image is displayed on the LCD 3200.

The panel controller (PANELC) 3106 controls the touch panel 3300 and the button device 3400 in response to a request from the CPU 3101. The control by the PANELC 3106 enables a pressed position on the touch panel 3300 and the key code that is pressed on the button device 3400 to be transmitted to the CPU 3101.

The power source controller 3104 is connected to a connector 3500 to thereby detect whether there is an electrical connection or no connection with the connector 2200 of the home position 2000. When the connector 3500 is connected with the connector 2200 of the home position 2000, the operation panel 3000 can receive supply of power from the power supply module 1500 of the main unit 1000. In this manner, power can be supplied to the operation panel 3000 overall while charging the rechargeable battery 3103 connected to the power source controller 3104. However when the connector 3500 and the connector 2200 of the home position 2000 are not connected, (when power is not supplied from the power source module 1500), the operation panel 3000 receives supply of power from the rechargeable battery 3103.

The IEEE802.11b module 3102 establishes wireless communication with the IEEE802.11b module 2101 on the home position 2000 based on the control of the CPU 3101, and mediates communication with the main unit 1000. The operation panel 3000 uses the IEEE802.11b module 3102 to perform wireless communication with the main unit 1000 and enables operation of the main unit 1000 from the operation panel 3000.

The irDA module 3109 establishes infrared communication with the irDA module 2102 on the home position 2000 based on the control of the CPU 3101, and mediates communication with the main unit 1000. The operation panel 3000 uses the irDA module 3109 to perform infrared communication with the main unit 1000 that mounts the operation panel 3000.

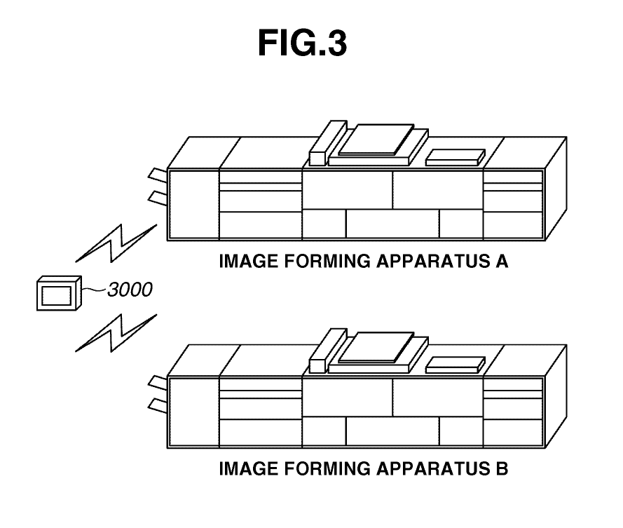

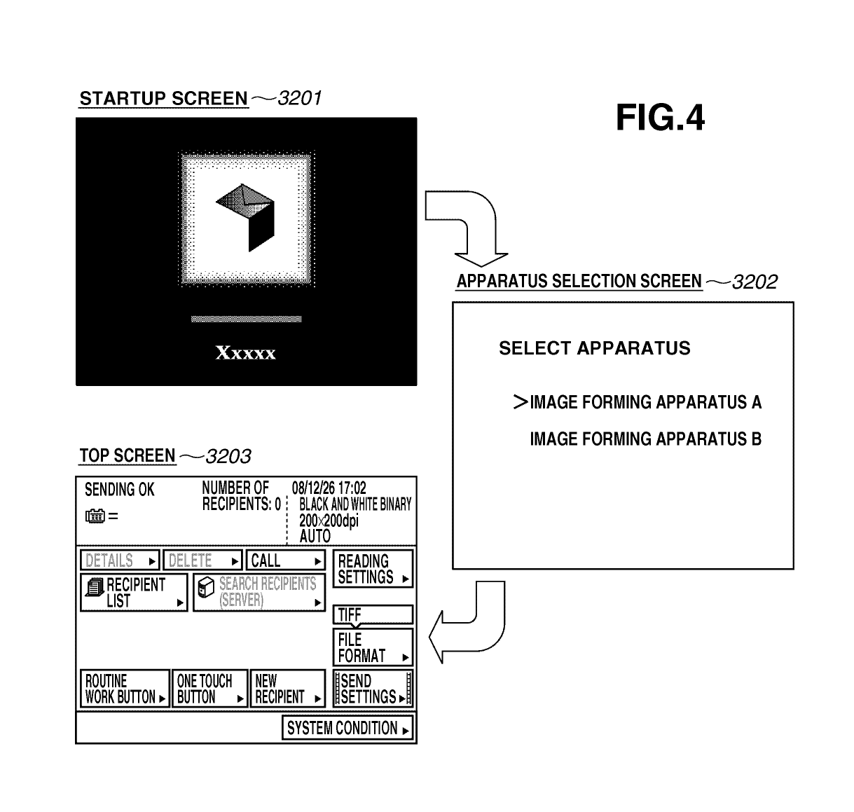

Referring to FIG. 3 and FIG. 4, the transition of a display screen when the power source is turned ON and a use state when the operation panel 3000 is removed from the home position 2000 on the main unit 1000 will be described.

FIG. 3 illustrates the use state of the detachable operation panel 3000 that characterizes the present invention is removed from the home position 2000 on the main unit 1000. FIG. 4 illustrates the transition of the display screen of the LCD 3200 when the power source is turned ON in a state that the detachable operation panel 3000 that characterizes the present invention is detached from the home position 2000 on the main unit 1000.

The operation panel 3000 is supplied the power from the rechargeable battery 3103 when a user turns On a power source switch (not illustrated) on the button device 3400. The CPU 3101 of the operation panel 3000 controls the LCD 3200 to display a startup screen 3201 (FIG. 4) thereon.

The CPU 3101 searches for an image forming apparatus (main unit) that can perform wireless communication using the IEEE802.11b module 3102. In the example illustrated in FIG. 3 and FIG. 4, it is assumed that the main unit of the image forming apparatus A and the main unit of the imaging forming apparatus B are detected by the above described searching process.

When the searching process is completed, the CPU 3101 displays a selection screen (an image forming apparatus selection screen 3202 in FIG. 4) on the LCD 3200 via the DISPC 3105. The selection screen displays selection options for selection of the main unit of the image forming apparatus with which wireless communication will be established of the main units of the image forming apparatuses that are searched. Video image (image data) of these display screens (screens 3201 and 3202 in FIG. 4) is stored in the FLASH ROM 3107 of the operation panel 3000. The image developed in the RAM 3108 when the power source is turned ON by the control of the CPU 3101 is read and displayed on the DISPC 3105. The CPU 3101 receives an input of a selection command by operation of the button device 3400 by a user via the PANELC 3106.

When the selection command is input, the CPU 3101 uses the IEEE802.11b module 3102 to establish wireless communication with the main unit of the selected image forming apparatus (first communication partner establishment processing). Thereafter, the main unit 1000 of the selected image forming apparatus reads the video image (a TOP screen (initial screen) 3203 of the selected apparatus) to be displayed on the LCD 3200 of the operation panel 3000 from the HDD 1400 and transfers the acquired image to the operation panel 3000.

The CPU 3101 in the operation panel 3000 receives the video image transferred from the main unit 1000 of the image forming apparatus with which wireless communication has been established, and performs control so that the received video image (TOP screen 3203) is displayed on the LCD 3200 of the operation panel 3000. The video image of the display screen on the LCD 3200 after the TOP screen 3203 is acquired from the main unit 1000 of the image forming apparatus which is a connection destination for wireless communication.

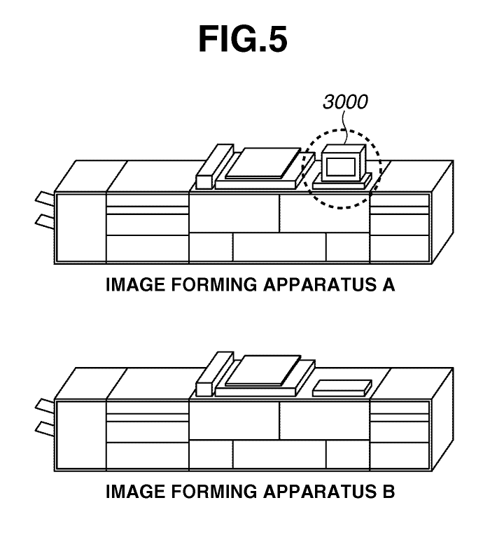

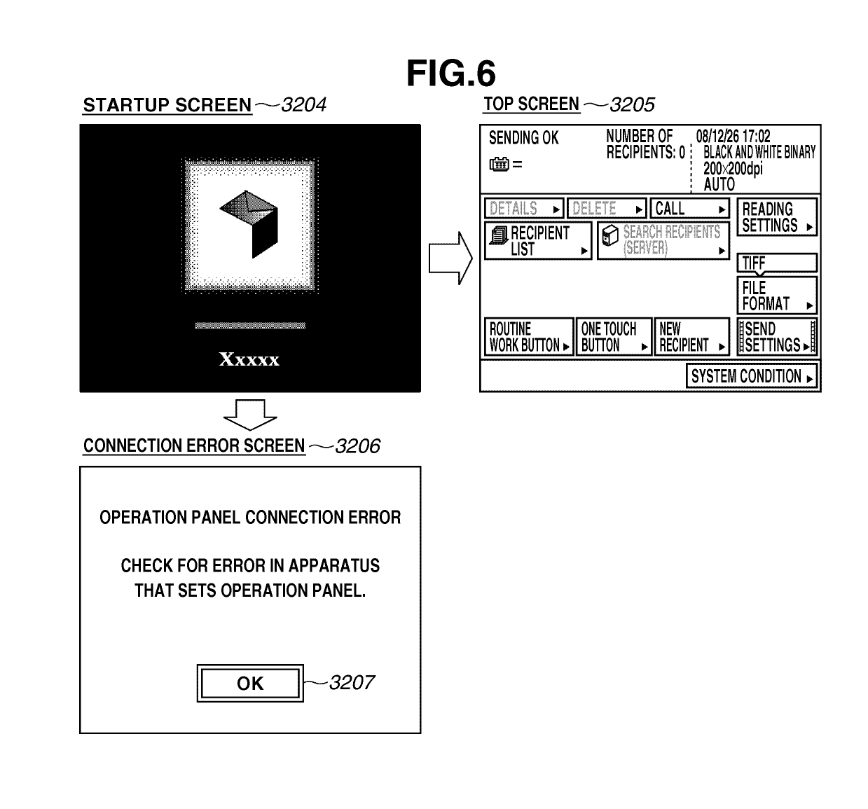

The transition of the display screen when the power source is turned ON and the use state when the operation panel 3000 is installed in the home position 2000 of the main unit 1000 will be described referring to FIG. 5 and FIG. 6.

FIG. 5 illustrates use state of the detachable operation panel 3000 that characterizes the present invention is positioned at the home position 2000 on the main unit 1000. FIG. 6 illustrates the transition of the display screen of the LCD 3200 when the power source is turned ON in a state that the detachable operation panel 3000 that characterizes the present invention is positioned at the home position 2000 on the main unit 1000.

A method for switching the power source to the operation panel 3000 that is installed in the home position 2000 of the main unit 1000 as illustrated in FIG. 5 is executed by either turning ON a power source switch (not illustrated) on the panel device 3400 or turning ON the power source of the main unit 1000.

The former method is enabled by starting up the power source module 1500 of the main unit 1000 via the power source controller 2103 of the home position 2000 from the power source controller 3104 of the operation panel 3000. At this time, although power from the rechargeable battery 3103 of the operation panel 3000 is temporarily used, after the main unit 1000 is started up, the operation panel 3000 switches to power supply from the power source module 1500 of the main unit 1000.

In the latter method, the operation panel 3000 receives power supply from the outset from the power source module 1500 of the main unit 1000. Power is also supplied from the main unit 1000 in the similar manner when the operation panel 3000 is installed on the home position 2000 (when the connector 3500 and the connector 2200 are electrically connected) in a state in which the main unit 1000 has the power source ON and the operation panel 3000 has the power source OFF.

As described above, when the power source is ON, the operation panel 3000 is controlled by the CPU 3101 to display a startup screen 3204 (FIG. 6) on the LCD 3200. The video image of the startup screen is stored in the FLASH ROM 3107 of the operation panel 3000. The CPU 3101 executes control so that the DISPC 3105 reads the image developed on the RAM 3108 when the power source is ON and displays the read image.

When the power source controller 3104 detects that the connector 3500 and the connector 2200 are electrically connected, the CPU 3101 acquires an extended service set identifier (ESSID) of the main body 1000 of the image forming apparatus A from the main body of the image forming apparatus A in the connection state using the irDA module 3109. The CPU 3101 starts wireless communication via the IEEE802.11b module 3102 and waits for a response (an ESSID notification) from the main body 1000 of the image forming apparatus A.

When the power source controller 2103 of the home position 2000 on which the operation panel 3000 is installed detects that the operation panel 3000 is connected, a notification to that effect is transmitted to the controller board 1100. The CPU 1101 of the controller board 1100 receives the notification and notifies the operation panel 3000 of its own ESSID via the sub-channel controller 1106. The CPU 1101 of the controller board 1100 responds (notifies an ESSID) to the operation panel 3000 via the IEEE802.11b module 3102.

The CPU 3101 of the operation panel 3000 that has received the response (notification of ESSID) via the IEEE802.11b module 3102 from the main unit 1000 of the image forming apparatus A establishes wireless communication with the main unit 1000 of the image forming apparatus A (second communication partner establishment processing). The main unit 1000 of the image forming apparatus A that has established wireless communication as described above reads the video image to be displayed on the LCD 3200 of the operation panel 3000 (a TOP screen 3205 of the connected apparatus in FIG. 6) from the HDD 1400, and transfers the video image to the operation panel 3000.

The CPU 3101 in the operation panel 3000 receives the video image transferred from the main unit 1000 of the image forming apparatus A with which wireless communication has been established, and performs control so that the received video image (TOP screen 3205) is displayed on the LCD 3200 of the operation panel 3000. The video image of the display screen on the LCD 3200 after the TOP screen 3205 is acquired from the main unit 1000 of the image forming apparatus which is a connection destination for wireless communication.

When a connection notification from the main unit 1000 of the connection-destination image forming apparatus A is not received within a predetermined time, the CPU 3101 of the operation panel 3000 determines that an error occurs in connection and displays a connection error screen 3206 on the LCD 3200. The video image of the connection error screen 3206 is stored in the FLASH ROM 3107 of the operation panel 3000.

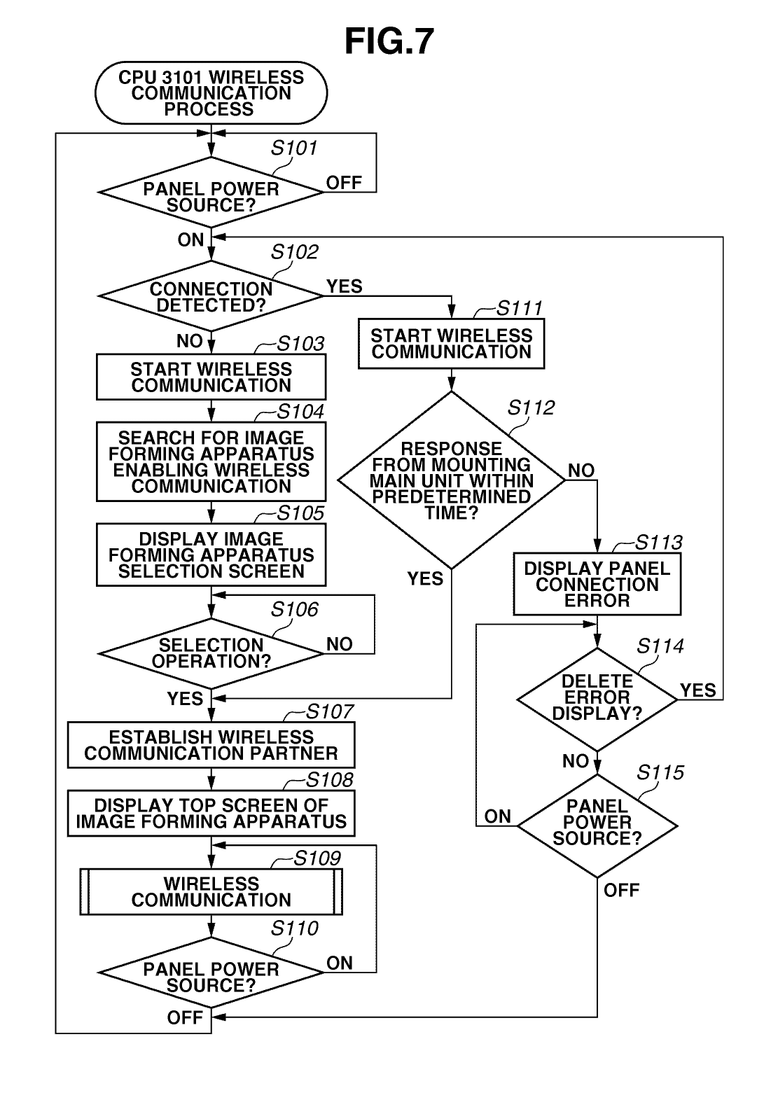

Processing of switching ON the power source of the operation panel 3000 will be described below with reference to FIG. 7. FIG. 7 is a flowchart illustrating the processing executed when the power source of the detachable operation panel 3000 that characterizes the present invention is turned ON. Each step in the flowchart illustrated in FIG. 7 is realized by the CPU 3101 of the operation panel 3000 reading and executing a control program stored in the FLASH ROM 3107. According to the description above, the operation panel 3000 and the main unit 1000 establish wireless communication with IEEE802.11b using a known technique. In FIG. 7, the units related to the establishment of wireless communication using the known technique are not illustrated.

In step S101, when the power source of the operation panel 3000 is switched ON, the CPU 3101 is started up. In step S102, the CPU 3101 detects whether the operation panel 3000 is installed at the home position 2000 of the main unit of the image forming apparatus via the power source controller 3104 (connection detection).

In step S102, when it is determined that the operation panel 3000 is not installed at the home position 2000 of the main unit of the image forming apparatus (NO in step S102), the CPU 2101 proceeds the processing to step S103.

In step S103, the CPU 3101 starts wireless communication by controlling the IEEE802.11b module 3102, and then the processing proceeds to step S104. At this time, the operation panel 3000 transmits a wireless communication connection request to nearby image forming apparatus main units.

In step S104, the CPU 3101 searches the main units of the image forming apparatuses that are capable of wireless communication via the IEEE802.11b module 3102. The CPU 3101 acquires an ESSID notified from the main unit of each image forming apparatus via the IEEE802.11b module 3102, and determines the main unit of the image forming apparatus from which the ESSID is acquired as the main unit of the image forming apparatus that is capable of wireless communication.

Next in step S105, the CPU 3101 causes the DISPC 3105 to display the apparatus selection screen 3202 (FIG. 4) that enables selection of the main unit among the main units of the image forming apparatuses enabling wireless communication (ESSID notification received) that were searched in step S104.

A name of the image formation apparatus may be displayed as a selection option on the apparatus selection screen 3202 in addition to the ESSID. The name of the image forming apparatus maybe notified together with the ESSID from the main unit of the image forming apparatus. Further, information associated with the image forming apparatus name and the ESSID may be recorded in advance in the FLASH ROM 3107 and used for the notification.

In step S106, the CPU 3101 waits until detection of a selection (selection command) of the main unit of the image forming apparatus by a user using the button device 3400 or the touch panel 3300.

In step S106, when it is determined that the selection operation by the user of the main unit of the image forming apparatus using the button device 3400 or the touch panel 3300 is detected (YES in step S106), the CPU 3101 proceeds the processing to step S107. In step S107, the CPU 3101 uses the ESSID of the main unit of the image forming apparatus selected in step S106 to associate the main unit of the selected image forming apparatus and establish the main unit of the selected image forming apparatus as a communication partner.

Then in step S108, the CPU 3101 acquires the TOP screen 3203 (FIG. 4) from the main unit of the image forming apparatus with which wireless communication was established in step S107, and displays the acquired TOP screen 3203 (FIG. 4) via the DISPC 3105 on the LCD 3200.

In step S109, the CPU 3101 exchanges the input and output signals with the image processing apparatus main unit with which wireless communication is established in step S107 while the power source switch (not illustrated) in the operation panel 3000 is ON (wireless communication). For example, the CPU 3101 executes wireless communication by transferring the input received from the touch panel 3300 or the button device 3400 to the main unit 1000 via the home position 2000, and receiving the transferred video image of the display screen from the main unit 1000.

In step S110, the CPU 3101 determines whether the power source switch of the operation panel 3000 is turned OFF. When the power source switch of the operation panel 3000 is OFF (OFF in step S110), the processing returns to step S101.

In step S102, when it is determined that the operation panel 3000 is mounted on the home position 2000 of the main unit of the image forming apparatus (YES in step S102), the CPU 3101 proceeds the processing to step S111. Although this is not illustrated, the CPU 3101 establishes communication using the irDA module 3109 and the main unit of the image forming apparatus mounting the operation panel 3000, acquires the ESSID of the main unit 1000 from the main unit 1000 and proceeds the processing to step S111.

In step S111, the CPU 3101 starts wireless communication by controlling the IEEE802.11b module 3102, and proceeds the processing to step S112.

In step S112, the CPU 3101 determines whether there has been a response (notification of ESSID) from the main unit 1000 of the image forming apparatus on which the operation panel 3000 is mounted within a predetermined time. When there is a wireless notification of an ESSID which is the same as the ESSID acquired using the above described sub-channel, the CPU 3101 determines that there was the response from the main unit 1000 of the image forming apparatus on which the operation panel 3000 is mounted.

When it is determined that there was the response from the main unit 1000 of the image forming apparatus on which the operation panel 3000 is mounted within the predetermined time (YES in step S112), the CPU 3101 proceeds the processing to step S107. In step S107, the CPU 3101 establishes wireless communication with the responding main unit.

On the other hand, when it is determined that there was not the response from the main unit 1000 of the image forming apparatus on which the operation panel 3000 is mounted within the predetermined time (NO in step S112), the CPU 3101 proceeds the processing to step S113.

In step S113, the CPU 3101 displays the connection error screen 3206 (FIG. 6) on the LCD 3200 via the DISPC 3105. In step S114, when the CPU 3101 detects an input operation, that is pressing of the OK button 3207 of the connection error screen 3206 using the touch panel 3300 or the button device 3400 (YES in step S114), the error display is deleted, and the operation panel 3000 is restarted.

On the other hand, when an input operation resulting from pressing the OK button 3207 of the connection error screen 3206 is not detected (NO in step S114), and the power source switch of the operation panel 3000 is switched OFF (OFF in step S110), the processing returns to step S101. Until the OK button 3207 is pressed, or the power source switch is turned OFF, the operation panel 3000 continues to display the connection error screen 3206 on the LCD 3200.

As described above, when starting up is performed in a state in which the operation panel that is detachable to the main unit of the image forming apparatus is mounted at the predetermined position on the main unit of the image forming apparatus, namely the main unit of the image forming apparatus to be operated is obvious, an operation for selecting the main unit of the image forming apparatus from the operation panel can be omitted. Therefore unnecessary operations during startup of the operation panel can be deleted, and user convenience can be improved.

In the present exemplary embodiment, although two image forming apparatus main units were described as an example, the same description applies to use of three or more image forming apparatuses.

Further, although the connection (detachment) of the operation panel 3000 and the home position 2000 of the main unit 1000 in the present exemplary embodiment is detected on the basis of whether connectors are electrically connected or disconnected, any configuration maybe employed as long as the configuration can detect physical installation thereof. For example, a mechanical configuration which can detect connection between the operation panel 3000 and the home position 2000 with an optical sensor may be used.

As described above, when the apparatus main unit that will execute wireless communication with an operation panel is determined at the time that the operation panel is started up, the cumbersome unnecessary operation by which a user selects the apparatus main unit for wireless communication can be omitted, and convenience can be improved.

In the first exemplary embodiment, when the power source of the detachable operation panel is switched ON, if the operation panel is not connected to the apparatus main unit, a wireless search is executed for a peripheral apparatus main unit, and the searched apparatus main unit is displayed on the image forming apparatus selection screen as an operation candidate.

However, the ESSID of the candidate image forming apparatus main units for connection (a plurality thereof) may be registered in advance in the FLASH ROM 3107. In other words, when the operation panel power source is switched ON, if the operation panel is not connected to the apparatus main unit, the main units of the image forming apparatus (plurality thereof) corresponding to the registered ESSIDs are displayed on the image forming apparatus selection screens as operation candidates.

In the first exemplary embodiment, an example using an IEEE802.11b module is used as a main channel (first communication). However, the IEEE802.11b module is not required. For example, communication adapted to another wireless communication technique such as Bluetooth can be used to enable the effect of the present invention. However, in this case, a unique ID is used in substitution of the ESSID as an identifier.

In the first exemplary embodiment, an irDA module is used as an example of a sub-channel (second communication). However, the sub-channel does not require use of the irDA module. For example, the effect of the present invention is obtained by provision of a connection point in the connector 2200 and the connector 3500 to thereby enable existing UART communication.

In the above exemplary embodiments, although an image forming apparatus is described as an example of an apparatus using the present invention, the present invention can be applied to any apparatus as long as the apparatus has an operation panel that can be detected from the apparatus main unit.

As described above, according to the exemplary embodiments of the present invention, if an apparatus main unit which performs an operation is determined such as when an operation panel that is detachable from the apparatus main unit is mounted in a predetermined position of the apparatus main unit at the time of start up, an operation using the operation panel to select an apparatus main unit to perform operation can be omitted. Thus, an unnecessary operation during startup of the operation panel can be deleted, and user convenience can be improved.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-267613 filed Nov. 25, 2009, which is hereby incorporated by reference herein in its entirety.

What is claimed is:

1. An operation apparatus detachable with respect to a plurality of image processing apparatuses and including a display unit which can display a selection screen for selecting an image processing apparatus as an operation target from among the plurality of image processing apparatuses, the operation apparatus comprising,
a control unit configured to display the selection screen on the display unit if the operation apparatus is started up when the operation apparatus is not mounted on any of the plurality of image forming apparatuses, and establish communication with an image processing apparatus selected via the selection screen,
wherein the control unit does not display the selection screen on the display unit if the operation apparatus is started up when the operation apparatus is mounted on any of the plurality of image forming apparatuses, and establishes communication with the image processing apparatus on which the operation apparatus is mounted.

2. The operation apparatus according to claim 1 further comprising:
a first communication unit configured to enable wired communication with the image processing apparatus; and
a second communication unit configured to enable wireless communication with the image processing apparatus,
wherein the control unit specifies, if the operation apparatus is started up when the operation apparatus is mounted on any of the plurality of image processing apparatuses, the image processing apparatus on which the operation apparatus is mounted by the first communication unit and establishes communication via the second communication unit with the image processing apparatus on which the operation apparatus is mounted.

3. The operation apparatus according to claim 1, wherein the control unit displays an operation screen on the display unit for operating the image processing apparatus based on data acquired from the image processing apparatus, if communication is established with any of the plurality of image processing apparatuses.

4. The operation apparatus according to claim 1, further comprising a notification unit configured to notify, if the operation apparatus is started up when the operation apparatus is mounted on any of the plurality of image processing apparatuses, occurrence of an error if the operation unit cannot communicate with the image processing apparatus on which the operation apparatus is mounted within a predetermined time.

5. The operation apparatus according to claim 1, further comprising a searching unit configured to search for an image processing apparatus that can communicate with the operation apparatus,
wherein the display unit displays a selection option corresponding to the image processing apparatus searched by the searching unit.

6. The operation apparatus according to claim 1, further comprising a registration unit configured to register the image processing apparatus that can communicate with the operation apparatus,
wherein the display unit displays a selection option corresponding to the image processing apparatus registered in the registration unit.

7. A method for controlling an operation apparatus detachable with respect to a plurality of image processing apparatuses and including a display unit which can display a selection screen for selecting an image processing apparatus as an operation target from among the plurality of image processing apparatuses, the method comprising:
displaying the selection screen on the display unit if the operation apparatus is started up when the operation apparatus is not mounted on any of the plurality of image forming apparatuses, and establishing communication with an image processing apparatus selected via the selection screen; and
not displaying the selection screen on the display unit if the operation apparatus is started up when the operation apparatus is mounted on any of the plurality of image forming apparatuses, and establishing communication with the image processing apparatus on which the operation apparatus is mounted.

8. A computer-readable storage medium storing a program for causing an operation apparatus detachable with respect to a plurality of image processing apparatuses and including a display unit which can display a selection screen for selecting an image processing apparatus as an operation target from among the plurality of image processing apparatuses to execute:
displaying the selection screen on the display unit if the operation apparatus is started up when the operation apparatus is not mounted on any of the plurality of image forming apparatuses, and establishing communication with an image processing apparatus selected via the selection screen; and
not displaying the selection screen on the display unit if the operation apparatus is started up when the operation apparatus is mounted on any of the plurality of image forming apparatuses, and establishing communication with the image processing apparatus on which the operation apparatus is mounted.
